(19) United States
(12) Patent Application Publication
(10) Pub. No.: US 2025/0297425 A1
(43) Pub. Date: Sep. 25, 2025

(54) Ink Jet Recording Method

(71) Applicant: SEIKO EPSON CORPORATION, Tokyo (JP)

(72) Inventor: Daisuke SAKUMA, Minowa (JP)

(21) Appl. No.: 19/087,954

(22) Filed: Mar. 24, 2025

(30) Foreign Application Priority Data
Mar. 25, 2024 (JP) 2024-048527

(51) Int. Cl. D06P 5/30; B41M 3/00; B41M 5/00; C09D 11/38; C09D 11/40; C09D 11/54; D06P 1/00; D06P 1/16; D06P 5/00

(52) U.S. Cl. CPC D06P 5/30; B41M 3/008; B41M 5/0011; C09D 11/38; C09D 11/40; C09D 11/54; D06P 1/002; D06P 1/16; D06P 5/002

(57) ABSTRACT

There is provided an ink jet recording method that includes a treatment liquid adhesion step of adhering a treatment liquid containing an organic acid and water to any place on a fabric by an ink jet method; a colored ink adhesion step of adhering a liquid droplet of a colored ink composition containing a pigment, an anionic first resin particle, and water to the any place by the ink jet method; and a transparent ink adhesion step of adhering a liquid droplet of a transparent ink composition containing an anionic second resin particle and water to the any place by the ink jet method. In the treatment liquid adhesion step, an amount of an acidic group derived from the organic acid adhering to the any place is 4.5 mmol/m² or more, and a shortest time difference |α| between adhesion of one of the colored ink composition and the treatment liquid composition to the any place and subsequent adhesion of another of the colored ink composition and the treatment liquid composition to the any place is within 5 min.

The present application is based on, and claims priority from JP Application Serial Number 2024-048527, filed Mar. 25, 2024, the disclosure of which is hereby incorporated by reference herein in its entirety.

### BACKGROUND

### 1. Technical Field

The present disclosure relates to an ink jet recording method.

### 2. Related Art

Ink jet recording methods can record high-definition images with a relatively simple apparatus and are rapidly developed in various fields. In such a process, various studies are made on color developing properties, fastness, and the like. In order to provide a textile printed matter having excellent frictional properties of a printed material while suppressing smearing, for example, JP-A-2022-180836 discloses a method for producing a textile printed matter, which includes a step of applying an ink containing a color material and water to a recording medium by an ink jet method, a step of applying a treatment liquid A to the recording medium to which the ink is applied, and a step of applying a treatment liquid B to the recording medium to which the treatment liquid A is applied, in which the treatment liquid B contains a water-dispersible resin, and the treatment liquid A contains an aggregating agent that aggregates the water-dispersible resin of the treatment liquid B.

However, in a recording method that is carried out by such a configuration in the related art as in JP-A-2022-180836, there is room for improvement in bleed-through resistance and friction fastness of a textile printed matter to be obtained.

### SUMMARY

An ink jet recording method according to the present disclosure includes a treatment liquid adhesion step of adhering a treatment liquid composition containing an organic acid and water to any place on a fabric by an ink jet method; a colored ink adhesion step of adhering a liquid droplet of a colored ink composition containing a pigment, an anionic first resin particle, and water to the any place by the ink jet method; and a transparent ink adhesion step of adhering a liquid droplet of a transparent ink composition containing an anionic second resin particle and water to the any place by the ink jet method. In the treatment liquid adhesion step, an amount of an acidic group derived from the organic acid adhering to the any place is 4.5 mmol/m² or more, and a shortest time difference |α| between adhesion of one of the colored ink composition and the treatment liquid composition to the any place and subsequent adhesion of another of the colored ink composition and the treatment liquid composition to the any place is within 5 min.

### BRIEF DESCRIPTION OF THE DRAWINGS

FIG. 1 is Table 1 that shows compositions of treatment liquid compositions used in Examples.

FIG. 2 is Table 2 that shows compositions of colored ink compositions used in Examples.

FIG. 3 is Table 3 that shows compositions of transparent ink compositions used in Examples.

FIG. 4 is Table 4 that shows configurations of the respective compositions and recording methods used in Examples, and evaluation results thereof.

FIG. 5 is Table 5 that shows configurations of the respective compositions and recording methods used in Examples, and evaluation results thereof.

FIG. 6 is Table 6 that shows configurations of the respective compositions and recording methods used in Examples, and evaluation results thereof.

FIG. 7 is Table 7 that shows configurations of the respective compositions and recording methods used in Examples, and evaluation results thereof.

FIG. 8 is Table 8 that shows configurations of the respective compositions and recording methods used in Examples, and evaluation results thereof.

FIG. 9 is view illustrating an example of a recording apparatus used in a recording method according to the present embodiment.

### DESCRIPTION OF EMBODIMENTS

Hereinafter, an embodiment of the present disclosure (hereinafter referred to as “the present embodiment”) is described in detail with reference to the drawings as necessary. However, the present disclosure is not limited thereto and can be variously modified without departing from the gist of the present disclosure. It is noted that in the drawings, the same elements are designated by the same reference numerals and the duplicated description will be omitted. In addition, the positional relationship, such as left, right, top, and bottom, should be based on the positional relationship illustrated in the drawings unless otherwise particularly specified. Further, the dimensional ratios in the drawings are not limited to the ratios illustrated in the drawings.

### Ink Jet Recording Method

An ink jet recording method (hereinafter, also referred to as the present recording method) according to the present embodiment includes a treatment liquid adhesion step of adhering a treatment liquid composition containing an organic acid and water to any place on a fabric by an ink jet method; a colored ink adhesion step of adhering a liquid droplet of a colored ink composition containing a pigment, an anionic first resin particle, and water to the any place by the ink jet method; and a transparent ink adhesion step of adhering a liquid droplet of a transparent ink composition containing an anionic second resin particle and water to the any place by the ink jet method. In the treatment liquid adhesion step, an amount of an acidic group derived from the organic acid adhering to the any place is 4.5 mmol/m² or more, and a shortest time difference |α| between adhesion of one of the colored ink composition and the treatment liquid composition to the any place and subsequent adhesion of another of the colored ink composition and the treatment liquid composition to the any place is within 5 min.

In recent years, in ink jet pigment textile printing, studies are carried out on a recording method in which a pretreatment liquid step to be carried out for reducing ink smearing or improving color developing properties and an ink adhering step are carried out with one recording apparatus. In such a method, the process is simplified, and the discharge of the waste liquid can be also eliminated. In particular, a Wet on Wet method in which drying between an adhesion step of a treatment liquid and an adhesion step of an ink is omitted has an advantage in terms of miniaturization and acceleration of the apparatus.

The treatment liquid uses an organic acid or a polyvalent metal salt as an aggregating agent for aggregating the ink. However, the polyvalent metal salt has strong aggregating power, and the wet friction fastness of a recorded matter to be obtained tends to decrease although a recorded matter in which color developing properties or bleed-through is suppressed is obtained. On the other hand, the organic acid undergoes a neutralization reaction with an anionic component of the ink thereby reducing the hydrophilicity of the anionic component. Therefore, it is possible to obtain a recorded matter having excellent wet friction fastness. In addition, by using an organic acid, the anionic component undergoes dispersion breakage, and the aggregation occurs in the vicinity of the surface of the fabric. As a result, it is also observed that the color developing properties are improved. However, the organic acid has a relatively weak aggregating power of the ink component due to the dispersion breakage, and there may be a case where a color material permeates into the fabric and the ink reaches the back surface (hereinafter, also referred to as “bleed-through”).

The cause of the bleed-through is not particularly limited; however, the cause is presumed to be that the treatment liquid containing the organic acid is dried until the ink lands, which causes a decrease in the effect of the neutralization reaction or dispersion breakage by the acid.

Therefore, in the present disclosure, by setting a timing to be within 5 minutes, where the timing is such that a treatment liquid containing a predetermined amount of an organic acid as an aggregating agent and a colored ink containing an anionic resin are each adhered, it is possible to carry out adhesion according to the Wet on Wet method, which suppresses bleed-through and also further improves color developing properties by allowing the neutralization reaction by the organic acid to proceed well, thereby promoting aggregation.

As the cause thereof, it is considered that the following fact contributes: the treatment liquid and the ink are adhered in a short time, thereby being easily mixed, and further, the treatment liquid contains an organic acid containing an amount of an acidic group of 4.5 mmol/m² or more, and the colored ink contains an anionic resin, whereby the aggregation reaction easily proceeds quickly in the vicinity of the surface of the fabric. However, the cause thereof is not limited to the cause described above.

In addition, in the present disclosure, by further adhering a transparent ink containing an anionic resin in addition to the colored ink composition, a coating film is formed from the transparent ink composition due to the effect of the organic acid in the reaction solution, and the wet friction fastness is further improved.

In the present specification, the term “any place” refers to a region of the fabric to which the treatment liquid composition, the colored ink composition, and the transparent ink composition are adhered, where layers formed from the respective compositions may be adhered in any place described above, in a state where a part or all of the layers overlap.

The present recording method is carried out on a fabric. Examples of the material of the fabric include natural fibers such as cotton, linen, wool, and silk, synthetic fibers such as polypropylene, polyesters, acetate, triacetate, polyamide, and polyurethane, and biodegradable fibers such as polylactic acid, and blended fibers thereof may be used.

The fabric preferably has a hydroxyl group. Examples of such a fabric include a fabric including cellulose such as cotton and linen, and a fabric including polyurethane. In a case where the fabric has a hydroxyl group, a crosslinking reaction can occur between an acidic component contained in the treatment liquid composition described later and the hydroxyl group of the fabric, and the effect of improving color developing properties by thickening and aggregation and the effect of improving friction fastness by improving adhesion between the fabric and the recording layer tend to be obtainable.

In the present recording method, the order of carrying out the treatment liquid adhesion step, the colored ink adhesion step, and the transparent ink adhesion step is not particularly limited. For example, after carrying out the treatment liquid adhesion step and the colored ink adhesion step at the same time, as necessary, the transparent ink adhesion step may be further carried out, or after carrying out the treatment liquid adhesion step, the colored ink adhesion step and the transparent ink adhesion step may be further carried out.

It is noted that, regarding the term “at the same time” here, it is assumed that, for example, the shortest time difference in the adhesion of each composition to any place is within 1 sec. As a specific configuration of the apparatus, in a case where an ink jet head, which has two or more of a nozzle row for ejecting a treatment liquid, a nozzle row for ejecting a colored ink, and a nozzle row for ejecting a transparent ink, is used, and two or more of the treatment liquid, the colored ink, and the transparent ink are ejected from the respective nozzle rows in a case where the ink jet head and the fabric are subjected to relative scanning, it is regarded that the order of landing is substantially not considered and the adhesions are carried out at the same time.

In the present recording method, a shortest time difference |α| between adhesion of one of the colored ink composition and the treatment liquid composition to any place and subsequent adhesion of another of the colored ink composition and the treatment liquid composition to the any place is set to be within 5 min. In a case where the time difference |α| is set to be within 5 minutes, the colored ink composition comes into contact with the treatment liquid in a state where the treatment liquid is not dried, and the neutralization reaction proceeds. Therefore, it is possible to obtain a textile printed matter having excellent bleed-through suppression, excellent color developing properties, and excellent friction fastness. From the same viewpoint, the time difference |α| is preferably within 1 min, within 1 sec, within 100 msec, and within 10 msec. The lower limit of the time difference |α| is not particularly limited since the case where the adhesions are carried out substantially at the same time as described above is also included; however, it is, for example, 0 sec or more and 1 msec or more.

In the present recording method, the shortest time difference |β| between adhesion of one of the colored ink composition and the transparent ink composition to any place of the fabric and subsequent adhesion of another of the colored ink composition and the transparent ink composition is adhered to the any place is preferably 1.0 sec or more and 5.0 sec or less, 1.5 sec or more and 4.5 sec or less, or 2.0 sec or more and 4.0 sec or less. In a case where the time difference |β| is set within the above-described range, the friction fastness tends to be further improved.

Hereinafter, each step and each composition included in the present recording method will be described in detail.

### 1. Treatment Liquid Adhesion Step

The present recording method includes a treatment liquid adhesion step of adhering a treatment liquid composition containing an organic acid and water to any place on a fabric by an ink jet method, where an amount of an acidic group derived from the organic acid adhering to the any place is 4.5 mmol/m² or more. Specifically, liquid droplets of the treatment liquid composition may be ejected to any place on the fabric by the ink jet head, thereby being adhered thereto. It is noted that the amount of the acidic group needs only to be 4.5 mmol/m² or more in at least a part of the region to which the treatment liquid composition is adhered, and it is also preferable to be 4.5 mmol/m² or more in the entire region.

The amount of the acidic group derived from the organic acid is preferably 6.0 to 60 mmol/m², 10 to 50 mmol/m², or 15 to 40 mmol/m². In a case where the amount of the acidic group derived from the organic acid, where the acidic group is adhered to the fabric, is within the above-described range, the neutralization reaction with the ink composition easily proceeds, and a textile printed matter to be obtained tends to have excellent friction fastness, excellent color developing properties, and excellent bleed-through resistance. It is noted that although a method for measuring an amount of an acidic group derived from an organic acid is not particularly limited, for example, the amount thereof can be measured by an acid-base titration method. Examples of the acidic group derived from the organic acid include an acidic group derived from the organic acid described below. Examples of the acidic group include a carboxyl group and a phosphoric acid group.

An adhesion amount X of the treatment liquid is preferably 5 to 90 g/m², 10 to 80 g/m², 15 to 60 g/m², or 17 to 30 g/m² per unit area of the recording region of the fabric. In a case where the adhesion amount X of the treatment liquid is within the above-described range, a textile printed matter to be obtained tends to have further excellent friction fastness and bleed-through resistance. It is noted that in the present specification, the adhesion amount and the coating amount have the same value.

### 1.1. Treatment Liquid Composition

The treatment liquid composition that is used in the present recording method contains an organic acid and water. It is noted that the treatment liquid is different from the colored ink composition that is used for fabric coloring and the transparent ink composition (overcoating liquid) described later, which is used for protecting a printed portion, and the treatment liquid is an auxiliary liquid that is used together with these compositions. The treatment liquid may be any treatment liquid as long as it can aggregate or thicken the components of the colored ink composition or the transparent ink composition.

### 1.1.1. Organic Acid

The molecular weight of the organic acid contained in the treatment liquid of the present recording method is preferably 5,000 or less, 4,000 or less, or 3,000 or less. In a case where the molecular weight of the organic acid is set within the above-described range, the friction fastness, the bleed-through resistance, and the color developing properties tend to be further excellent. It is noted that one kind of organic acid may be used alone, or two or more kinds thereof may be used in combination.

Suitable examples of the specific compound include, as an organic acid, lactic acid, succinic acid, phosphoric acid, polyacrylic acid, acetic acid, glycolic acid, malonic acid, malic acid, maleic acid, ascorbic acid, glutaric acid, fumaric acid, citric acid, tartaric acid, sulfonic acid, orthophosphoric acid, pyrrolidone carboxylic acid, pyrone carboxylic acid, pyrrole carboxylic acid, furan carboxylic acid, pyridine carboxylic acid, coumarin acid, thiophene carboxylic acid, nicotinic acid, or derivatives of these compounds, or salts thereof. Among these, from the viewpoint of further improving the bleed-through resistance, color developing properties, and friction fastness of the textile printed matter, it is preferable to include one or more selected from the group consisting of lactic acid, succinic acid, phosphoric acid, and polyacrylic acid.

The content of the organic acid is preferably 1.0% to 30.0% by mass, 1.5% to 20.0% by mass, 3.0% to 15.0% by mass, or 7.0% to 15.0% by mass with respect to the total amount of the treatment liquid composition. In a case where the content of the organic acid is set within the above-described range, the friction fastness, the bleed-through resistance, and the color developing properties tend to be further excellent.

### 1.1.2 Organic Solvent

The treatment liquid may contain an organic solvent. The organic solvent is not particularly limited as long as it is water-soluble, and examples thereof include polyhydric alcohols, glycol ethers, nitrogen-containing solvents, ether, and cyclic esters. Among these, polyhydric alcohols are preferable from the viewpoint of further improving friction fastness, bleed-through resistance, and color developing properties. It is noted that one kind of organic solvent may be used alone, or two or more kinds thereof may be used in combination.

The polyhydric alcohols can be classified into, for example, polyols and alkanediols. Specific examples of the polyols include glycerin, ethylene glycol, propylene glycol, 1,2-propanediol, 1,2-butanediol, 1,3-propanediol, 1,4-butanediol, diethylene glycol, triethylene glycol, dipropylene glycol, and trimethylolpropane. Among these, it is preferable that the treatment liquid contains at least one of glycerin or propylene glycol from the viewpoint of more effectively and reliably exhibiting the effect of the present disclosure.

In addition, Specific examples of the alkanediols include 1,2-pentanediol, 1,2-hexanediol, 1,2-octanediol, 1,6-hexanediol, 2-methyl-2,4-pentanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, and the like.

Further, specific examples of the glycol ethers include triethylene glycol monobutyl ether, ethylene glycol monomethyl ether, ethylene glycol monoethyl ether, ethylene glycol monopropyl ether, ethylene glycol monobutyl ether, ethylene glycol monomethyl ether acetate, diethylene glycol monomethyl ether, diethylene glycol monoethyl ether, diethylene glycol monopropyl ether, diethylene glycol monobutyl ether, diethylene glycol mono-t-butyl ether, 1-methyl-1-methoxybutanol, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, propylene glycol monobutyl ether, dipropylene glycol monobutyl ether, 3-methoxy-3-methyl-1-butanol, ethylene glycol dimethyl ether, ethylene glycol diethyl ether, ethylene glycol dibutyl ether, diethylene glycol dimethyl ether, and diethylene glycol diethyl ether.

The content of the organic solvent is preferably 10% to 50% by mass, 15% to 45% by mass, or 20% to 40% by mass with respect to the total amount of the treatment liquid composition. In a case where the content of the organic solvent is set within the above-described range, the friction fastness, the bleed-through resistance, and the color developing properties tend to be further excellent. From the same viewpoint, the content of the polyhydric alcohols or polyols is preferably 10% to 50% by mass, 15% to 45% by mass, or 20% to 40% by mass with respect to the total amount of the treatment liquid composition.

### 1.1.3 Surfactant

The treatment liquid may contain a surfactant. Examples of the surfactant include an acetylene glycol-based surfactant, a fluorine-based surfactant, and a silicone-based surfactant, and an acetylene glycol-based surfactant is preferably used. In a case where the acetylene glycol-based surfactant is used, it is possible to more effectively and reliably exhibit the effect of the present disclosure. It is noted that one kind of surfactant may be used alone, or two or more kinds thereof may be used in combination.

Examples of the acetylene glycol-based surfactant include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, DF110D (hereinabove, all product names, manufactured by Air Products and Chemicals, Inc.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, AE-3 (hereinabove, all product names, manufactured by Nissin Chemical Co., Ltd.), and ACETYLENOL E00, E00P, E40, E100 (hereinabove, all product names, manufactured by Kawaken Fine Chemicals Co., Ltd.). It is preferable to use OLFINE E1010 from the viewpoint of more effectively and reliably exhibiting the effect of the present disclosure.

The content of the surfactant is preferably 0.1% to 5.0% by mass, 0.5% to 3.0% by mass, or 0.8% to 2.0% by mass with respect to the total amount of the treatment liquid composition. In a case where the content of the surfactant in the treatment liquid is set within the above-described range, it is possible to more effectively and reliably exhibit the effect of the present disclosure.

### 1.1.4. Water

The treatment liquid contains water. As the water, it is preferable to use water from which ionic impurities are removed as much as possible, and examples of such water include pure water such as ion exchange water, ultrafiltration water, reverse osmosis water, or distilled water, and ultrapure water.

The content of water is preferably 30% to 90% by mass more preferably 40% to 80% by mass, and still more preferably 50% to 75% by mass with respect to the total amount of the treatment liquid composition. In a case where the content of the water in the treatment liquid is set within the above-described range, it is possible to more effectively and reliably exhibit the effect of the present disclosure.

### 1.1.5 Antibacterial Agent

The treatment liquid may contain an antibacterial agent. Examples of the antibacterial agent include sodium benzoate, sodium pentachlorophenol, sodium 2-pyridinethiol-1-oxide, sodium sorbate, sodium dehydroacetate, and 1,2-dibenzisothiazolin-3-one (PROXEL CRL, PROXEL BDN, PROXEL GXL, PROXEL XL2, PROXEL TN, and PROXEL LV as product names, from Lonza Japan Ltd.), 4-chloro-3-methylphenol (PREVENTOL CMK from Bayer AG), and the like. PROXEL XL2 is preferable.

The content of the antibacterial agent in the treatment liquid is preferably 0.01% to 1.0% by mass, more preferably 0.1% to 0.5% by mass, and still more preferably 0.2% to 0.4% by mass with respect to the total amount of the treatment liquid composition. In a case where the content of the antibacterial agent is set within the above-described range, it is possible to more effectively and reliably exhibit the effect of the present disclosure.

### 1.1.6. Other Components

As components other than those described above, the treatment liquid that is used in the present recording method may contain, for example, various additives such as a pH adjusting agent, a metal sealing agent, a softening agent, a dissolution aid, a viscosity adjusting agent, an ultraviolet absorbing agent, an antioxidant, and a corrosion inhibitor as necessary.

### 2. Colored Ink Adhesion Step

The present recording method includes a colored ink adhesion step of adhering a liquid droplet of a colored ink composition containing a pigment, an anionic first resin particle, and water to the any place of the fabric. Specifically, liquid droplets of the colored ink composition may be ejected to any place on the fabric by the ink jet head, thereby being adhered thereto. At any place on the fabric, the treatment liquid adhered in advance and the colored ink may be reacted with each other, or the colored ink may be adhered in advance and then allowed to react with the treatment liquid.

In the present recording method, an adhesion amount Y of the colored ink composition per unit area is preferably 10 g/m² or more in the recording region to which the colored ink is adhered. In a case where such a relationship is satisfied, a textile printed matter to be obtained tends to have further excellent friction fastness. From the same viewpoint, the adhesion amount Y is more preferably 10 to 45 g/m², 20 to 40 g/m², or 17 to 80 g/m². In a case where the adhesion amount Y of the colored ink composition per unit area is 10 g/m² or more, it may be disadvantageous in terms of the bleed-through or the fastness. However, according to the present recording method, the amount of the acidic group derived from the organic acid is 4.5 mmol/m² or more in a region in which the adhesion amount Y of the colored ink composition per unit area is 10 g/m² or more, and thus the bleed-through resistance and the friction fastness can be made favorable.

### 2.1. Colored Ink Composition

The colored ink composition contains a pigment, an anionic first resin particle, and water. The anionic first resin particle contained in the colored ink composition reacts with an acidic component in the treatment liquid, thereby reducing the affinity for water and proceeding aggregation in the vicinity of the surface. As a result, the friction fastness, the color developing properties, and the bleed-through resistance are improved.

### 2.1.1. Pigment

As the pigment, the following pigment can be used: for example, an organic pigment such as an azo pigment (including, for example, azo lake, an insoluble azo pigment, a condensed azo pigment, a chelate azo pigment, or the like), a polycyclic pigment (for example, a phthalocyanine pigment, a perylene pigment, a perinone pigment, an anthraquinone pigment, a quinacridone pigment, a dioxazine pigment, a thioindigo pigment, an isoindolinone pigment, a quinophthalone pigment, or the like), a nitro pigment, a nitroso pigment, or aniline black; an inorganic pigment such as carbon black (for example, furnace black, thermal lamp black, acetylene black, channel black, or the like), a metal oxide, a metal sulfide, or a metal chloride; or an extender pigment such as calcium carbonate or talc. Among these, it is preferable to use carbon black, which is an inorganic pigment, from the viewpoint of more effectively and reliably exhibiting the effect of the present disclosure. It is noted that one kind of pigment may be used alone, or two or more kinds thereof may be used in combination.

The pigment is preferably a self-dispersing pigment. In a case where the self-dispersing pigment is contained, a neutralization reaction with the organic acid in the treatment liquid proceed easily, and the bleed-through resistance, the friction fastness, and the color developing properties tend to be improved.

Examples of the carbon black include Colour Index Generic Name (C.I.) Pigment Black 1, 7, and 11. Commercially available products of carbon black may be used, and examples thereof include No. 2300, No. 900, MCF88, No. 33, No. 40, No. 45, No. 52, MA7, MA8, MA100, No. 2200B, and the like from Mitsubishi Chemical Corporation, Raven (registered trademark) 5750, 5250, 5000, 3500, 1255, 700, and the like from Columbia Carbon Inc., Regal (registered trademark) 400R, 330R, and 660R, Mogul (registered trademark) L, Monarch (registered trademark) 700, 800, 880, 900, 1000, 1100, 1300, 1400, and the like from Cabot Corporation, and Color Black FW1, FW2, FW2V, FW18, FW200, S150, S160, and S170, Printex (registered trademark) 35, U, V, and 140U, and Special Black 6, 5, 4A, 4, and the like from Evonik Corporation. In addition, it is preferable to use those prepared by the method described in Examples described later.

The content of the pigment in the colored ink is preferably 1% to 10% by mass, 2% to 8% by mass, or 3% to 7% by mass with respect to the total amount of the colored ink composition. In a case where the content of the pigment is set within the above-described range, it is possible to more effectively and reliably exhibit the effect of the present disclosure. It is noted that the content of the pigment in the colored ink is based on % by mass of the pigment solid content.

### 2.1.2. Anionic First Resin Particle

Examples of the anionic first resin particles include those in which a resin constituting the resin particles has an anionic group. Examples of the anionic group include a sulfonic acid group, a carboxyl group, a phosphoric acid group, and a hydroxyl group. It is noted that the resin particle is a particle containing a resin, and although any resin particle that is in an emulsion state and in a solution state can be used, it is preferable to use a resin particle in an emulsion state from the viewpoint of suppressing an increase in the viscosity of the ink.

More specific examples of the anionic first resin particles include those made from a urethane resin, a polycarbonate resin, a (meth)acrylic resin, a styrene resin, a silicone resin, a styrene acrylic resin, a fluorene resin, a polyolefin resin, a rosin-modified resin, a terpene resin, a polyester resin, a polyamide resin, an epoxy resin, a vinyl chloride resin, a vinyl chloride-vinyl acetate copolymer, and an ethylene vinyl acetate resin. Among these, a urethane resin is preferable from the viewpoint of more effectively and reliably exhibiting the effect of the present disclosure.

The urethane resin is a resin having a urethane bond in the molecule. Examples of the urethane resin include a polyether-type urethane resin including an ether bond in the main chain, a polyester-type urethane resin including an ester bond in the main chain, and a polycarbonate-type urethane resin including a carbonate bond in the main chain, in addition to a urethane bond. Specific commercially available product thereof include ETERNACOLL UW-1501F, UW-1527F, and UW-5002 (hereinabove, product names, manufactured by UBE Corporation), TAKELAC WS-5000, W-6061, W-6110, WS-5984, and WS-5100 (hereinabove, product names, manufactured by Mitsui Chemicals, Inc.), PERMARIN UA-150 and UA-200, and U-COAT UX-390 (hereinabove, product names, manufactured by Sanyo Chemical Industries, Ltd.), HYDRAN WLS-210 (product name, manufactured by DIC Corporation), and the like. Among these, from the viewpoint of more effectively and reliably exhibiting the effect of the present disclosure, a polycarbonate-type urethane resin is preferable, and UW-1527F is preferable as a commercially available product of the polycarbonate-type urethane resin.

The content of the anionic first resin particles in the colored ink is preferably 1% to 15% by mass, 3% to 10% by mass, or 5% to 7% by mass with respect to the total amount of the colored ink composition. In a case where the content of the anionic first resin particle is set within the above-described range, it is possible to more effectively and reliably exhibit the effect of the present disclosure. It is noted that the above-described content is based on % by mass of the solid content of the anionic first resin particles.

### 2.1.3. Organic Solvent

The colored ink may contain an organic solvent. The organic solvent is not particularly limited as long as it is water-soluble, and the same kind as that used in the treatment liquid may be used. Preferably, it includes polyhydric alcohols or glycol ethers.

The colored ink preferably contains glycerin as an organic solvent of the polyhydric alcohols and preferably contains triethylene glycol monobutyl ether as an organic solvent of the glycol ethers. In a case where these compounds are contained, it is possible to more effectively and reliably exhibit the effect of the present disclosure.

The content of the organic solvent in the colored ink is preferably 5% to 30% by mass, 10% to 25% by mass, or 15% to 20% by mass with respect to the total amount of the colored ink composition. In a case where the content of the organic solvent is set within the above-described range, the friction fastness, the bleed-through resistance, and the color developing properties tend to be further excellent. From the same viewpoint, the content of the polyhydric alcohols is preferably 5% to 30% by mass or 10% to 25% by mass with respect to the total amount of the colored ink composition, and the content of the glycol ethers is preferably 0.5% to 5% by mass or 1% to 3% by mass with respect to the total amount of the colored ink composition.

### 2.1.4. pH Adjusting Agent

The colored ink composition may contain a pH adjusting agent. The pH adjusting agent is not particularly limited; however, examples thereof include an appropriate combination of an acid, a base, a weak acid, and a weak base. Examples of such an acid and such a base include, as inorganic acids, sulfuric acid, hydrochloric acid, nitric acid, and the like; and, as inorganic bases, lithium hydroxide, sodium hydroxide, potassium hydroxide, potassium dihydrogen phosphate, sodium dihydrogen phosphate, potassium carbonate, sodium carbonate, sodium hydrogen carbonate, and ammonia. In addition, examples of the organic base include triethanol amine (TEA), diethanol amine, monoethanol amine, tripropanol amine, triisopropanol amine, diisopropanol amine, and tris(hydroxymethyl)aminomethane (TRAM), and organic acids such as adipic acid, citric acid, succinic acid, lactic acid, Good's buffers such as N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyl iminobisacetic acid (ADA), piperazine-1,4-bis(2-ethanesulfonic acid) (PIPES), N-(2-acetamide)-2-aminoethanesulfonic acid (ACES), cholamine chloride, N-tris(hydroxymethyl)methyl-2-aminoethanesulfonic acid (TES), acetamide glycine, tricine, glycine amide, and bicine, a phosphate buffer solution, a citrate buffer solution, a Tris buffer solution, or the like may be used. Among these, triethanol amine is preferable from the viewpoint of more effectively and reliably exhibiting the effect of the present disclosure.

The content of the pH adjusting agent in the colored ink is preferably 0.1% to 5% by mass, 0.3% to 3% by mass, or 0.5% to 1.5% by mass with respect to the total amount of the colored ink composition. In a case where the content of the pH adjusting agent is set within the above-described range, it is possible to more effectively and reliably exhibit the effect of the present disclosure.

For the surfactant, the antibacterial agent, the water, and the other components, which can be contained in the colored ink, the same kinds as those used in the above-described treatment liquid composition can be used within the same content ranges.

### 3. Transparent Ink Adhesion Step

The present recording method includes a transparent ink adhesion step of adhering a liquid droplet of a transparent ink composition containing an anionic second resin particle and water to any place by the ink jet method. Specifically, liquid droplets of the transparent ink composition may be ejected to any place on the fabric by the ink jet head, thereby being adhered thereto. At any place on the fabric, the transparent ink composition may be adhered at the same time as the treatment liquid or the colored ink, or may be adhered in a form of being further mixed on the treatment liquid or colored ink adhered in advance. In a case where the transparent ink composition is adhered, the friction fastness is excellent.

An adhesion amount Z of the transparent ink is preferably 5 to 50 g/m², 10 to 45 g/m², 20 to 40 g/m², or 17 to 80 g/m² per unit area of the recording region of the fabric. In a case where the adhesion amount Z of the transparent ink is within the above-described range, a textile printed matter to be obtained tends to be further excellent in friction fastness and bleed-through resistance.

In the present recording method, it is preferable that the adhesion amount X of the treatment liquid per unit area, the adhesion amount Y of the colored ink composition per unit area, and the adhesion amount Z of the transparent ink composition per unit area satisfy a relationship of the following numerical expression (1). In a case where such a relationship is satisfied, a textile printed matter to be obtained tends to have further excellent color developing properties. From the same viewpoint, a value of (Y+Z)/X is preferably 1.2 or more, and more preferably 1.4 or more.

$$( Y + Z ) / X \geq 1.1 \qquad ( 1 )$$

In the present recording method, it is preferable that an area A of a first region to which the treatment liquid is adhered, an area B of a second region to which the colored ink composition is adhered, and an area C of a third region to which the transparent ink composition is adhered satisfy a relationship of the following numerical expression (2). In a case where such a relationship is satisfied, a textile printed matter to be obtained tends to have further excellent friction fastness, color developing properties, and bleed-through resistance.

$$C \geq A \geq B \qquad ( 2 )$$

### 3.1. Transparent Ink Composition

The transparent ink composition contains anionic second resin particles and water.

### 3.1.1. Anionic Second Resin Particle

The anionic second resin particles contained in the transparent ink composition are not particularly limited; however, the same anionic first resin particles as those used in the colored ink composition described above can be used.

The content of the anionic second resin particles in the transparent ink composition is preferably 3% to 30% by mass, 5% to 20% by mass, or 7% to 15% by mass with respect to the total amount of the transparent ink composition. In a case where the content of the anionic second resin particle is set within the above-described range, it is possible to more effectively and reliably exhibit the effect of the present disclosure.

### 3.1.2. Organic Solvent

The transparent ink may contain an organic solvent. The organic solvent is not particularly limited as long as it is water-soluble, and the same kind as that used in the treatment liquid may be used. Preferably, it includes polyhydric alcohols or glycol ethers.

The transparent ink preferably contains glycerin as an organic solvent of the polyhydric alcohols and contains triethylene glycol monobutyl ether as an organic solvent of glycol ethers. In a case where these compounds are contained, it is possible to more effectively and reliably exhibit the effect of the present disclosure.

The content of the organic solvent in the transparent ink is preferably 5% to 40% by mass, 10% to 30% by mass, or 15% to 25% by mass with respect to the total amount of the transparent ink composition. In a case where the content of the organic solvent is set within the above-described range, the friction fastness, the bleed-through resistance, and the color developing properties tend to be further excellent. From the same viewpoint, the content of the polyhydric alcohols is preferably 5% to 40% by mass or 10% to 30% by mass with respect to the total amount of the transparent ink composition, and the content of the glycol ethers is preferably 0.5% to 5% by mass or 1% to 3% by mass with respect to the total amount of the transparent ink composition.

For the surfactant, the organic solvent, the antibacterial agent, the water, and the other components, which can be contained in the transparent ink, the same kinds as those used in the above-described treatment liquid composition can be used within the same content ranges. In addition, for the pH adjusting agent, the same kinds as those used in the above-described colored ink composition can be used within the same content ranges.

### 4. Other Steps

The recording method may include steps other than the treatment liquid adhesion step, the colored ink adhesion step, and the transparent ink adhesion step, which are described above. For example, a step of heating the fabric may be further provided after the above-described step. The heating method is not particularly limited, and examples thereof include a heat press method, a normal pressure steam method, a high pressure steam method, and a thermofix method.

### 5. Ink Jet Recording Apparatus

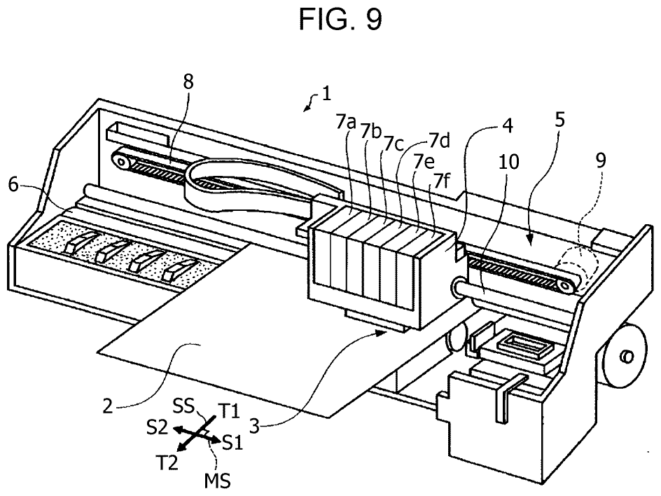

An example of an ink jet textile printing apparatus including an ink jet head, which can be applied to the recording method according to the present embodiment, will be described with reference to FIG. 9.

The ink jet textile printing apparatus used in the following description is a serial printer in which an ink jet head for recording is mounted on a carriage that moves in a predetermined direction, and the ink jet head moves with the movement of the carriage to eject liquid droplets to the fabric. The ink jet textile printing apparatus that can be applied to the recording method according to the present embodiment is not limited to a serial printer, and it may be a line printer. A line printer is a type of printer in which an ink jet head is formed to be wider than the width of a fabric, and liquid droplets are ejected to the fabric without moving the ink jet head.

The ink jet textile printing apparatus is an apparatus for printing by landing liquid droplets on a fabric by an ink jet head as a liquid ejection portion that ejects minute liquid droplets of an ink composition or a treatment liquid. FIG. 9 is a schematic perspective view illustrating an ink jet textile printing apparatus used in the embodiment.

As illustrated in FIG. 9, a printer 1 in the present embodiment includes an ink jet head 3, a carriage 4, a main scanning mechanism 5, a platen roller 6, and a control portion (not shown) that controls the operation of the entire printer 1. The carriage 4 is equipped with the ink jet head 3, and liquid cartridges 7a, 7b, 7c, 7d, 7e, and 7f for storing an ink composition and a treatment liquid supplied to the ink jet head 3 are detachable.

The main scanning mechanism 5 includes a timing belt 8 coupled to the carriage 4, a motor 9 that drives the timing belt 8, and a guide shaft 10. The guide shaft 10 serves as a support member for the carriage 4 and extends in a scanning direction of the carriage 4, that is, in a main scanning direction MS. The carriage 4 is driven by the motor 9 with the timing belt 8 interposed therebetween and can reciprocate along the guide shaft 10. As a result, the main scanning mechanism 5 has a function of reciprocating the carriage 4 in the main scanning direction MS.

The platen roller 6 has a function of transporting a fabric 2 subjected to textile printing in a sub-scanning direction SS orthogonal to the main scanning direction MS, that is, in a length direction of the fabric 2. As a result, the fabric 2 is transported in the sub-scanning direction SS. The carriage 4 on which the ink jet head 3 is mounted is configured to reciprocate in the main scanning direction MS, which substantially coincides with a width direction of the fabric 2, and the ink jet head 3 is configured to relatively scan the fabric 2 in the main scanning direction MS and the sub-scanning direction SS.

The liquid cartridges 7a, 7b, 7c, 7d, 7e, and 7f are six independent liquid cartridges. The liquid cartridges 7a, 7b, 7c, 7d, 7e, and 7f can store the ink composition and the treatment liquid used in the recording method in the present embodiment. In these liquid cartridges, the ink composition and the treatment liquid exhibiting colors such as black, cyan, magenta, yellow, white, and orange are individually stored, and can be used in any combination. In FIG. 9, the number of liquid cartridges is set to 6, but the number is not limited thereto. At the bottom part of the liquid cartridges 7a, 7b, 7c, 7d, 7e, and 7f, there are provided supply ports (not shown) for supplying the ink composition or treatment liquid stored in each liquid cartridge to the ink jet head 3.

The ink jet head 3 is a unit that sprays the ink composition and the treatment liquid supplied from the liquid cartridges 7a, 7b, 7c, 7d, 7e, and 7f from a plurality of nozzles to the fabric 2 under control by a control portion (not shown) and adhering thereof. The ink jet head 3 is provided with the plurality of nozzles for ejecting the ink composition and the treatment liquid and adhering thereof to the fabric 2 on a surface opposing the fabric 2 to which the ink composition and the treatment liquid are adhered. The plurality of nozzles are disposed in a row to form a nozzle row, and the nozzle row is individually disposed corresponding to each color ink composition and treatment liquid. Each color ink composition and treatment liquid are supplied to the ink jet head 3 from each liquid cartridge, and are ejected as liquid droplets from a nozzle by an actuator (not shown) in the ink jet head 3. In a case where the ejected liquid droplets of the ink composition and the treatment liquid land on the fabric 2, and adhesion treatment on the fabric 2 is carried out, an image, a text, a pattern, a color, and the like using the ink are formed on a textile printed region of the fabric 2. It is noted that a plurality of the ink jet heads 3 may be provided in the carriage 4.

Here, in the ink jet head 3, a piezoelectric element is used as an actuator which is a drive unit, but the method is not limited thereto. For example, an electromechanical conversion element that displaces a vibration plate as an actuator by electrostatic adsorption, or an electrothermal conversion element that ejects an ink composition as liquid droplets by air bubbles generated by heating may be used.

The ink jet head 3 has a nozzle group for treatment liquid for ejecting a treatment liquid and a nozzle group for ink composition for ejecting an ink composition. The nozzle group from which ejection is carried out means a nozzle group used for recording in the recording method. In a case where there is an image to be temporarily recorded on a region of the fabric opposing the nozzle group at a time of carrying out the main scanning, the nozzle group is a nozzle group for ejecting an ink and the like from the nozzle, and a nozzle group continuous in the sub-scanning direction SS. Therefore, a nozzle group, which exists as the nozzle group itself but is not used for recording in the recording method, is not included in the ejection nozzle group.

The printer 1 may be provided with a drying unit or a heating unit (neither of which is shown). The drying unit and the heating unit are units that efficiently dry the treatment liquid or the ink adhered to the fabric 2. As long as the drying unit and the heating unit are provided at positions at which the fabric 2 can be dried and heated, the installation positions thereof are not particularly limited. In order to efficiently dry the ink or the treatment liquid adhered to the fabric 2, for example, in FIG. 9, the drying unit and the heating unit can be installed at a position opposing the ink jet head 3.

Examples of the drying unit and the heating unit include a print heater mechanism that heats the fabric 2 in contact with a heat source, a mechanism that performs irradiation with infrared rays or microwaves, which are electromagnetic waves having a maximum wavelength of approximately 2,450 MHz, and the like, and a dryer mechanism that blows warm air. Heating of the fabric 2 is carried out before or in a case where the liquid droplets ejected from the nozzle of the ink jet head 3 are adhered to the fabric 2. Various heating conditions, for example, timing of heating execution, heating temperature, heating time, and the like are controlled by the control portion.

In addition, the drying unit and the heating unit may be installed on the downstream of the fabric 2 in the transport direction. In this case, the ink or the treatment liquid ejected from the nozzle is adhered to the fabric 2 to form an image, and then the fabric 2 is heated. As a result, drying properties of the ink or the treatment liquid adhered to the fabric 2 are improved.

### Examples

Hereinafter, the present disclosure will be described in more detail with reference to examples and comparative examples. The present disclosure is not limited by following Examples.

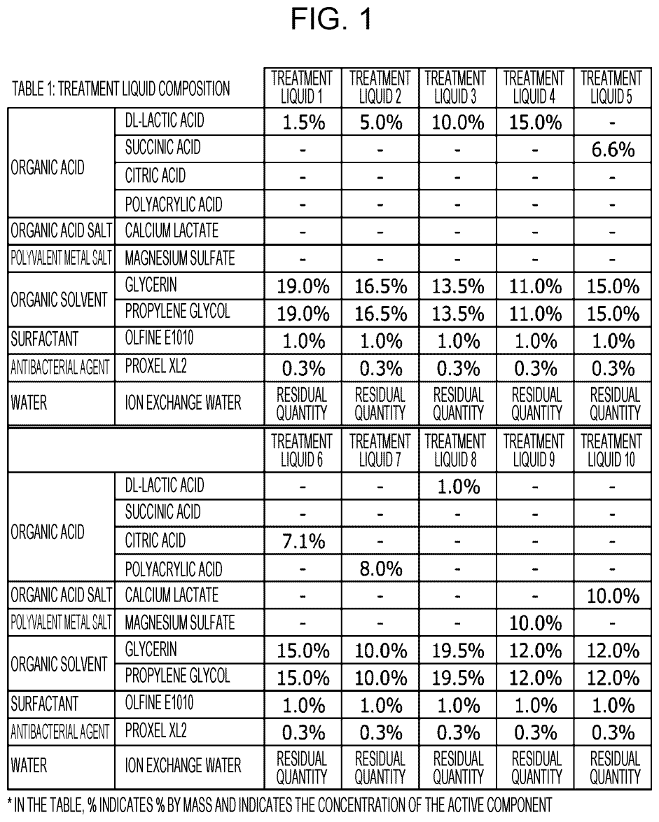

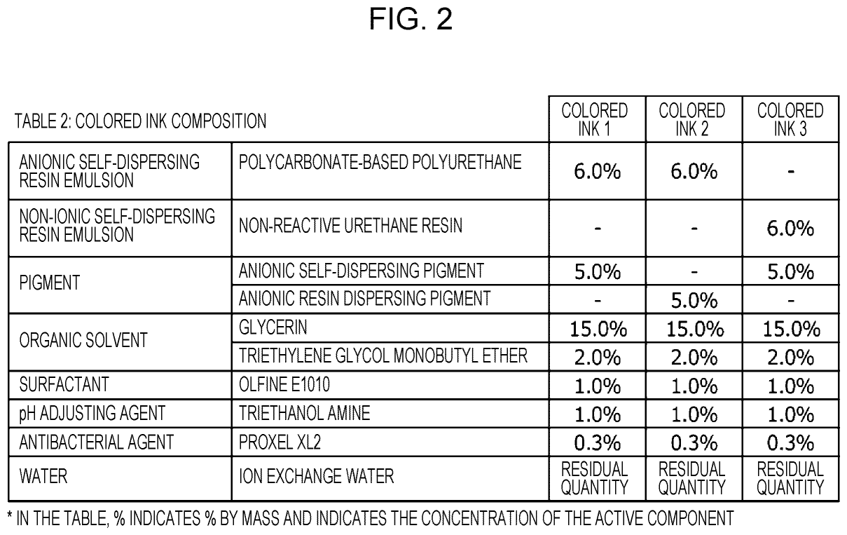

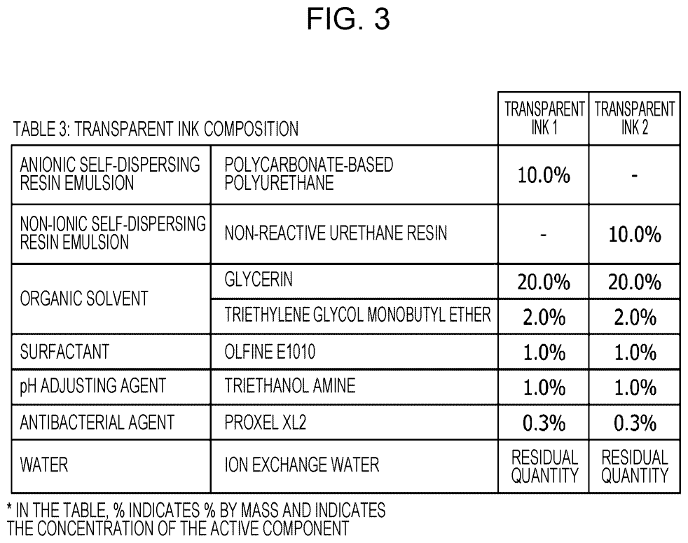

Table 1 to Table 3 showing the configuration of the composition of each of examples and comparative examples are described in FIG. 1 to FIG. 3.

### 1. Preparation of Each Composition

The respective components were put into a tank for a mixture so that the composition described in Table 1 to Table 3 was obtained. Then, they were mixed and stirred, and then filtered through a membrane filter to obtain a treatment liquid composition, a colored ink composition, and a transparent ink composition of each example. It is noted that the numerical value of each component shown in each example in the table indicates a ratio in terms of % by mass based on the total mass of the corresponding composition unless otherwise specified.

The details of the abbreviations and product components used are as follows.

### 1.1. Treatment Liquid Composition

### Organic Acid

DL-lactic acid
Succinic acid
Citric acid
Polyacrylic acid

### Organic Acid Salt

Calcium lactate

### Polyvalent Metal Salt

Magnesium sulfate

### Organic Solvent

Glycerin
Propylene glycol

### Surfactant

OLFINE E1010 (product name, acetylene glycol-based surfactant, manufactured by Nissin Chemical Co., Ltd.) Antibacterial Agent
PROXEL XL2 (product name, manufactured by Lonza Japan Ltd.)

### Water

Ion exchange water

### 1.2. Colored Ink

### Anionic Self-Dispersing Resin Emulsion

Polycarbonate-based polyurethane (product name “UW1527F”, manufactured by UBE Corporation)

### Nonionic Self-Dispersing Resin Emulsion

Non-reactive urethane resin (product name “SUPERFLEX 500M”, manufactured by DKS Co., Ltd.)

### Anionic Self-Dispersing Pigment

500 g of carbon black bulk powder prepared by a furnace method (primary particle diameter=18 nm, BET specific surface area=180 m²/g, DBP absorption amount=186 mL/100 g) was added to 3750 g of ion exchange water, and the temperature was raised to 45° C. while carrying out stirring with a dissolver. After that, 30,000 g of an aqueous solution of sodium hypochlorite (effective chlorine concentration=12%) was added dropwise over 3.5 hours at 45° C. while pulverizing with a sand mill using zirconia beads having a diameter of 0.8 mm. Subsequently, the pulverization with the sand mill was continued for a further 30 minutes to obtain a reaction solution containing a self-dispersing type carbon black. The reaction solution was filtered using 400 mesh wire net, and thus the zirconia beads and unreacted carbon black were separated from the reaction solution. A 5% potassium hydroxide aqueous solution was added to the reaction solution obtained through the separation to adjust the pH to 7.5. Desalination and purification were then carried out using an ultrafiltration membrane until the electrical conductivity of the liquid reached 1.5 mS/cm. Desalination and purification were then further carried out using an electrodialyzer until the electrical conductivity of the liquid reached 1.0 mS/cm. The liquid was then concentrated until the self-dispersing type carbon black concentration reached 17% by mass. The concentrate was subjected to centrifugal separation with a centrifugal separator to remove coarse particles, followed by filtration through a 0.6 μm filter. Ion exchange water was added to the filtrate obtained to dilute the filtrate until the self-dispersing type carbon black concentration reached 15% by mass, and dispersion was carried out to obtain self-dispersing pigment dispersion liquid.

### Anionic Resin Dispersing Pigment

To 15 parts by mass of carbon black, 10 parts by mass of ammonium salt (weight average molecular weight: 10,000) of a styrene-acrylic acid copolymer as a dispersing agent was added as a polymer component, and 55 parts by mass of ion exchange water was added thereto, followed by sufficient mixing. Then, the mixture was dispersed for 2 hours together with glass beads (diameter: 1.7 mm, 1.5 times the amount of the mixture) in a sand mill (manufactured by Yasukawa Seisakusho Co., Ltd.). After dispersion, the glass beads were removed to obtain a resin dispersing pigment dispersion liquid.

### Organic Solvent

Glycerin
Triethylene glycol monobutyl ether

### Surfactant

OLFINE E1010 (product name, acetylene glycol-based surfactant, manufactured by Nissin Chemical Co., Ltd.)

### pH Adjusting Agent

Triethanol amine

### Antibacterial Agent

PROXEL XL2 (product name, manufactured by Lonza Japan Ltd.)

### Water

Ion exchange water

### 1.3. Transparent Ink

### Anionic Self-Dispersing Resin Emulsion

Polycarbonate-based polyurethane (product name “UW1527F”, manufactured by UBE Corporation)

### Nonionic Self-Dispersing Resin Emulsion

Non-reactive urethane resin (product name “SUPERFLEX 500M”, manufactured by DKS Co., Ltd.)

### Organic Solvent

Glycerin
Triethylene glycol monobutyl ether

### Surfactant

OLFINE E1010 (product name, acetylene glycol-based surfactant, manufactured by Nissin Chemical Co., Ltd.)

### pH Adjusting Agent

Triethanol amine

### Antibacterial Agent

PROXEL XL2 (product name, manufactured by Lonza Japan Ltd.)

### Water

Ion exchange water

### 2. Textile Printing Recording Method

Using an apparatus modified from PX-H8000 (manufactured by Seiko Epson Corporation), a medium to be recorded which is 100% cotton and white broad was subjected to printing under the conditions described in Table 4 to Table 8 below, and main scanning was carried out on the same scanning region a plurality of times (2 times, 4 times, 8 times, 12 times, or 16 times) to form a solid pattern image on an A4 size fabric which is the medium to be recorded. After that, a heating treatment and drying were carried out at 160° C. for 3 minutes in an oven to prepare a textile printed matter according to each example and each comparative example. It is noted that the “solid pattern image” means an image in which dots are recorded for all pixels of the pixel which is the minimum recording unit region defined by a recording resolution (Duty 100%).

It is noted that as the ink jet head, a head unit having a distance between nozzles of 600 dpi in a width direction of the medium to be recorded and 600 nozzles was used. In addition, in each example, the head nozzle groups used were such that the head nozzle group that ejects the treatment liquid and the head nozzle group that ejects the colored ink composition had a portion that is located at the same position in the sub-scanning direction, and the head nozzle group that ejects the non-colored ink composition is located downstream of the head nozzle group that ejects the colored ink composition, in the sub-scanning direction. As a result, the treatment liquid and the colored ink composition were adhered to the same scanning region of the fabric by the same main scanning, and the non-colored ink composition was adhered to the same scanning region of the fabric by main scanning which was different from the same main scanning described above.

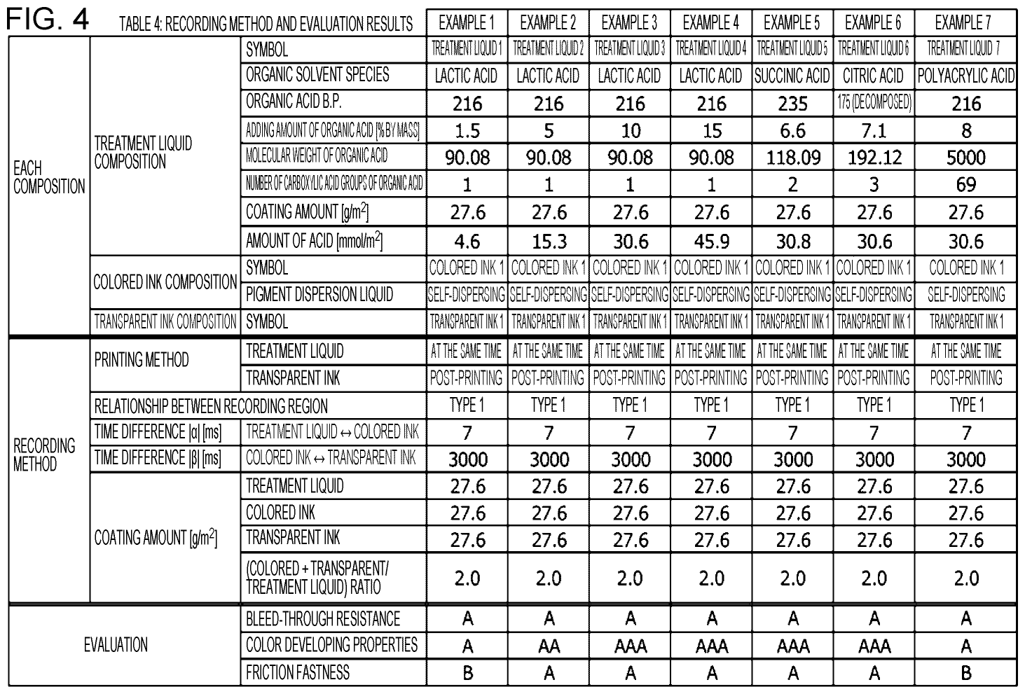

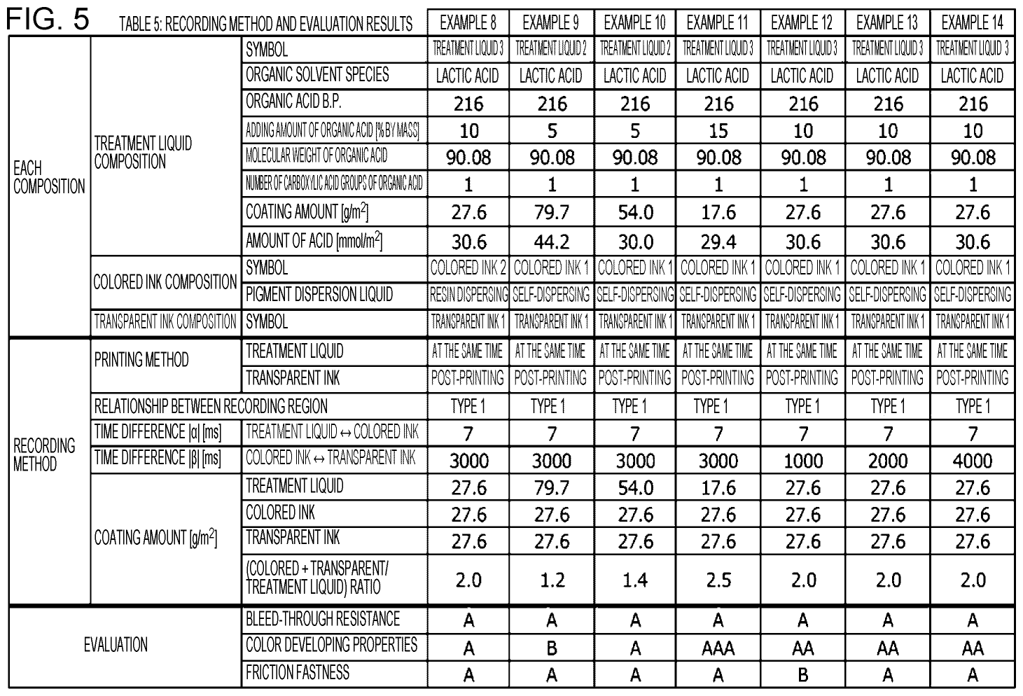

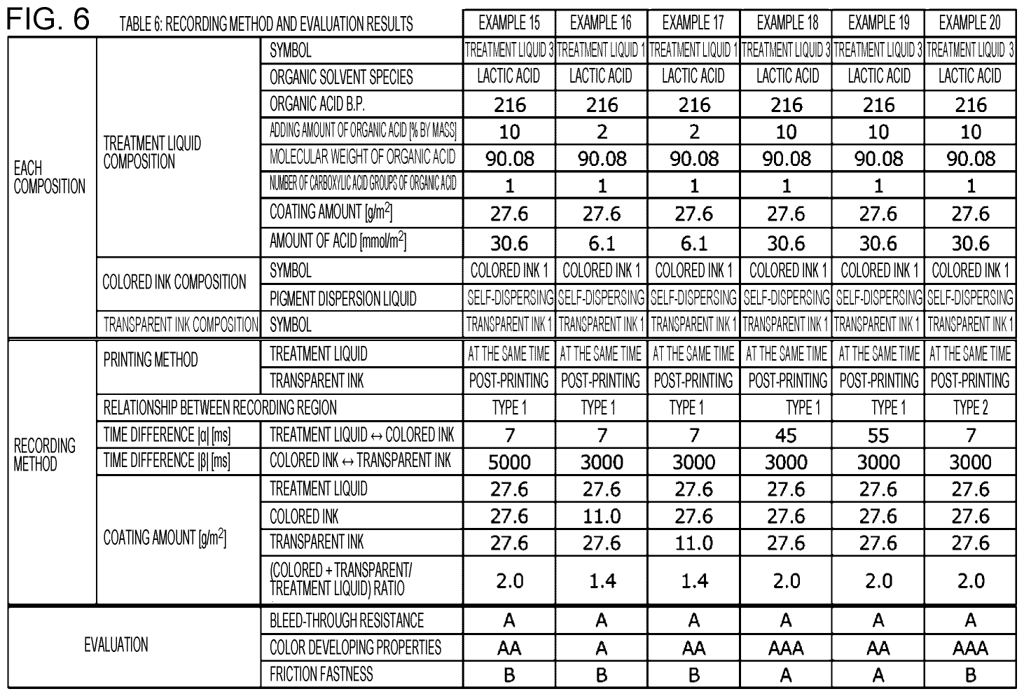

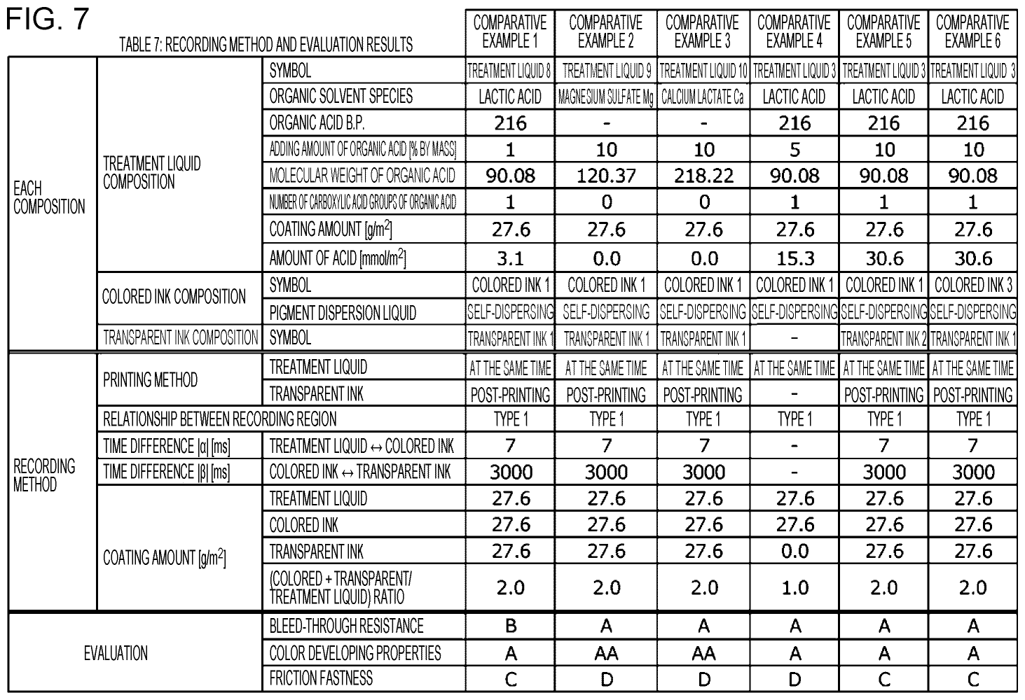

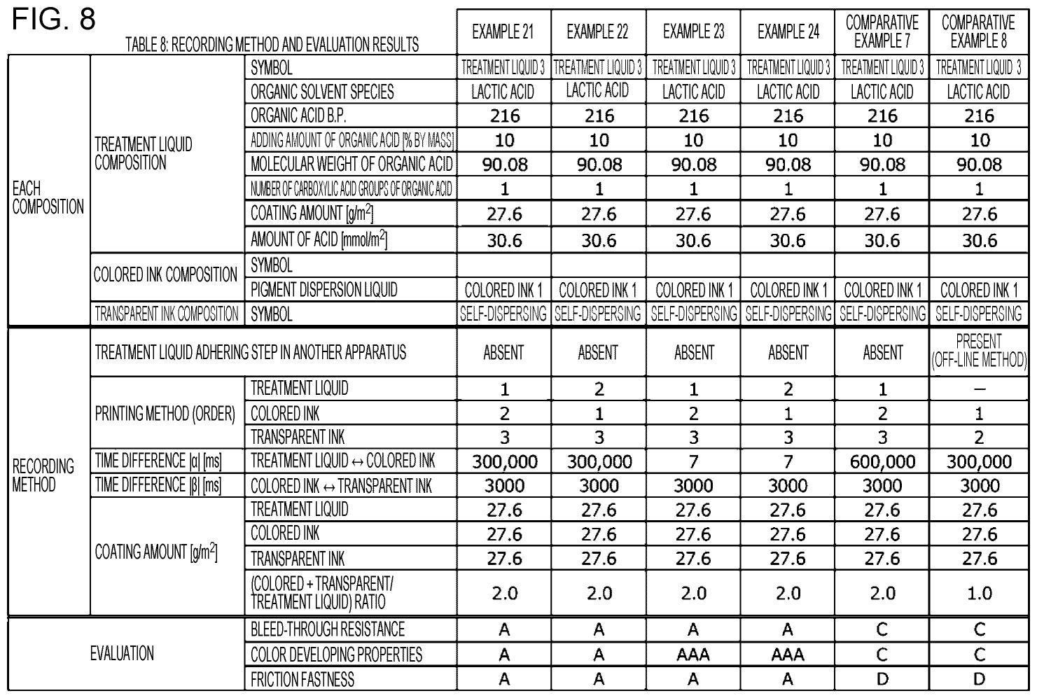

Table 4 to Table 8 showing the configuration of the composition and recording method of each of examples and the evaluation results thereof are described in FIG. 4 to FIG. 8. Table 4 to Table 8, the “at the same time” in the printing method means that a simultaneous adhesion step of adhering the treatment liquid composition and the colored ink composition to the same operating region of the fabric by the same main scanning. In addition, the “post-printing” means that after the simultaneous adhesion step, a transparent ink adhesion step is carried out, where the transparent ink adhesion step is a step of adhering the transparent ink composition to the fabric side by main scanning different from the main scanning in the simultaneous adhesion step.

Table 4 to Table 8, the recording regions indicate that the recording regions have the following relationship. It is noted that in a case where there is no particular description in the table, the type is Type 1.

### Relationship Between Recording Region

Type 1: The treatment liquid adhesion step and the transparent ink adhesion step are carried out on the equivalent regions, and the colored ink adhesion step is carried out on a region (a region included in the regions for the treatment liquid and the transparent ink) narrower than the equivalent regions.
Type 2: The treatment liquid adhesion step, the colored ink adhesion step, and the transparent ink adhesion step are carried out on regions that are equivalent to each other.
Type 3: The colored ink adhesion step is carried out on a region narrower than the region in which the treatment liquid adhesion step is carried out, and the transparent ink adhesion step is carried out on a region narrower than the region in which the colored ink adhesion step is carried out.

It is noted that although not described in the table, in a case where the relationship between the recording regions is changed to Type 3 in Example 20, it is possible to obtain the effect corresponding to the friction fastness evaluation B described later, although the friction fastness is inferior to that of Example 20.

In addition, in Comparative Example 8 in Table 8, the treatment liquid 3 was uniformly applied onto a white broad fabric of 100% cotton by using a roller so that the coating amount was 27.6 g/m². After coating, a heating treatment was carried out at 160° C. for 2 minutes in an oven. After that, the fabric was transferred into the apparatus described above and then subjected to a colored ink composition adhesion step and a transparent ink composition adhesion step in this order.

### 3. Evaluation Method

### 3.1. Bleed-Through Resistance

An OD value of black of the printed back surface of the textile printed matter obtained above was measured using a fluorescence spectrophotometer (“FD-7”, manufactured by Konica Minolta, Inc.) to evaluate the state of bleed-through according to the following standards. In a case where the evaluation result is B or higher, it can be said that the bleed-through is suppressed, and the contamination of the transport system can be prevented.

### Evaluation Standards

A: The maximum OD value is less than 0.46.
B: The maximum OD value is 0.46 or more and less than 0.6.
C: The maximum OD value is 0.6 or more.

### 3.2. Color Developing Properties

An OD value of black of the printed surface of the textile printed matter obtained above was measured using a fluorescence spectrophotometer (“FD-7”, manufactured by Konica Minolta, Inc.) to evaluate color developing properties according to the following standards. In a case where the evaluation result is B or higher, it can be said that favorable color developing properties are obtained.

### Evaluation Standards

AAA: The maximum OD value is 1.50 or more.
AA: The maximum OD value is 1.47 or more and less than 1.50.
A: The maximum OD value is 1.44 or more and less than 1.46.
B: The maximum OD value is 1.40 or more and less than 1.44.
C: The maximum OD value is less than 1.40.

### 3.3. Friction Fastness

The friction fastness of the textile printed matter obtained above was tested by a test method in accordance with ISO105-X12, and wet friction fastness was evaluated according to the following standards. In a case where the evaluation result is B or higher, it can be said that favorable wet friction fastness is obtained.

### Evaluation Standards

A: Friction fastness has a grade of 3 or higher.
B: Friction fastness has a grade of 2 or 3 or higher and a grade of less than 3.
C: Friction fastness has a grade of 2 or higher and a grade lower than 2 or 3.
D: Friction fastness has a grade of less than 2.

### 4. Evaluation Results

From Table 4 to Table 8, it can be seen that the bleed-through resistance and the friction fastness are excellent in a case where recording is carried out by an ink jet recording method which includes a treatment liquid adhesion step of adhering a treatment liquid composition containing an organic acid and water to any place on a fabric by an ink jet method; a colored ink adhesion step of adhering a liquid droplet of a colored ink composition containing a pigment, an anionic first resin particle, and water to the any place by the ink jet method; and a transparent ink adhesion step of adhering a liquid droplet of a transparent ink composition containing an anionic second resin particle and water to the any place by the ink jet method, where in the treatment liquid adhesion step, an amount of an acidic group derived from the organic acid adhering to the any place is 4.5 mmol/m² or more, and a shortest time difference |α| between adhesion of one of the colored ink composition and the treatment liquid composition to the any place and subsequent adhesion of another of the colored ink composition and the treatment liquid composition to the any place is within 5 min.

What is claimed is:

1. An ink jet recording method comprising:
a treatment liquid adhesion step of adhering a treatment liquid composition containing an organic acid and water to any place on a fabric by an ink jet method;
a colored ink adhesion step of adhering a liquid droplet of a colored ink composition containing a pigment, an anionic first resin particle, and water to the any place by the ink jet method; and
a transparent ink adhesion step of adhering a liquid droplet of a transparent ink composition containing an anionic second resin particle and water to the any place by the ink jet method, wherein
in the treatment liquid adhesion step, an amount of an acidic group derived from the organic acid adhering to the any place is 4.5 mmol/m² or more, and
a shortest time difference |α| between adhesion of one of the colored ink composition and the treatment liquid composition to the any place and subsequent adhesion of another of the colored ink composition and the treatment liquid composition to the any place is within 5 min.

2. The ink jet recording method according to claim 1, wherein
the time difference |α| is within 10 msec.

3. The ink jet recording method according to claim 1, wherein
a shortest time difference |β| between adhesion of one of the colored ink composition and the transparent ink composition to the any place and subsequent adhesion of another of the colored ink composition and the transparent ink composition is adhered to the any place is 1.0 sec or more and 5.0 sec or less.

4. The ink jet recording method according to claim 1, wherein
a molecular weight of the organic acid is 5,000 or less.

5. The ink jet recording method according to claim 1, wherein
the pigment is a self-dispersing pigment.

6. The ink jet recording method according to claim 1, wherein
an adhesion amount X of the treatment liquid per unit area, an adhesion amount Y of the colored ink composition per unit area, and an adhesion amount Z of the transparent ink composition per unit area satisfy a relationship of the following numerical expression (1),
$$( Y + Z ) / X \geq 1.1 . \qquad ( 1 )$$

7. The ink jet recording method according to claim 1, wherein
in a recording region to which the colored ink is adhered, an adhesion amount Y of the colored ink composition per unit area is 10 g/m² or more.

8. The ink jet recording method according to claim 1, wherein
an area A of a first region to which the treatment liquid is adhered, an area B of a second region to which the colored ink composition is adhered, and an area C of a third region to which the transparent ink composition is adhered satisfy a relationship of the following numerical expression (2),
$$C \geq A \geq B . \qquad ( 2 )$$
